(19) United States
(12) Patent Application Publication
(10) Pub. No.: US 2025/0077215 A1
(43) Pub. Date: Mar. 6, 2025

(54) COMPUTER AND SOFTWARE UPDATE METHOD

(71) Applicant: Toshiba Tec Kabushiki Kaisha, Tokyo (JP)

(72) Inventor: Naoya SATO, Izunokuni Shizuoka (JP)

(21) Appl. No.: 18/460,995

(22) Filed: Sep. 5, 2023

(51) Int. Cl. G06F 8/65; G06F 9/4401

(52) U.S. Cl. CPC G06F 8/65; G06F 9/4401

(57) ABSTRACT

A computer includes a storage device that includes a first partition in which a current version of software is written and a second partition used as a swap area and a processor that controls the storage device. The processor invalidates the swap area of the second partition when updating the current version of the software to a new version of the software. The processor writes the new version of the software to the second partition.

### FIELD

Embodiments described herein relate generally to a computer and a software update method.

### BACKGROUND

A program recovery method can be used when updating software.

### DESCRIPTION OF THE DRAWINGS

FIG. 1 is a hardware configuration diagram of a computer according to at least one embodiment;

FIG. 2 is a diagram illustrating a partition configuration of an SSD of FIG. 1;

FIG. 3 is a diagram illustrating a software configuration of firmware installed in the SSD of FIG. 1;

FIG. 4 is a flowchart of a software update program of FIG. 3;

FIG. 5 is a diagram illustrating the partition configuration of the SSD after execution of ACT 11 in the flowchart of FIG. 4;

FIG. 6 is a diagram illustrating the partition configuration of the SSD after execution of ACT 15 in the flowchart of FIG. 4;

FIG. 7 is an implementation example of a command for executing ACT 15 in the flowchart of FIG. 4;

FIG. 8 is a diagram illustrating the partition configuration of the SSD after execution of ACT 16 in the flowchart of FIG. 4;

FIG. 9 is a flowchart of a system boot program of FIG. 3; and

FIG. 10 is a diagram illustrating the partition configuration of the SSD after execution of ACT 28 in the flowchart of FIG. 9.

### DETAILED DESCRIPTION

A program recovery method in which, when updating software, a current version of software is saved in a backup storage unit before downloading a new version of software is started is described.

In general, according to at least one embodiment, there is provided a computer including a storage device that includes a first partition in which a current version of software is written and a second partition used as a swap area and a processor that controls the storage device. The processor invalidates the swap area of the second partition when updating the current version of the software to a new version of the software and writes the new version of the software to the second partition.

Hereinafter, a computer according to at least one embodiment will be described with reference to the drawings.

### Hardware Configuration

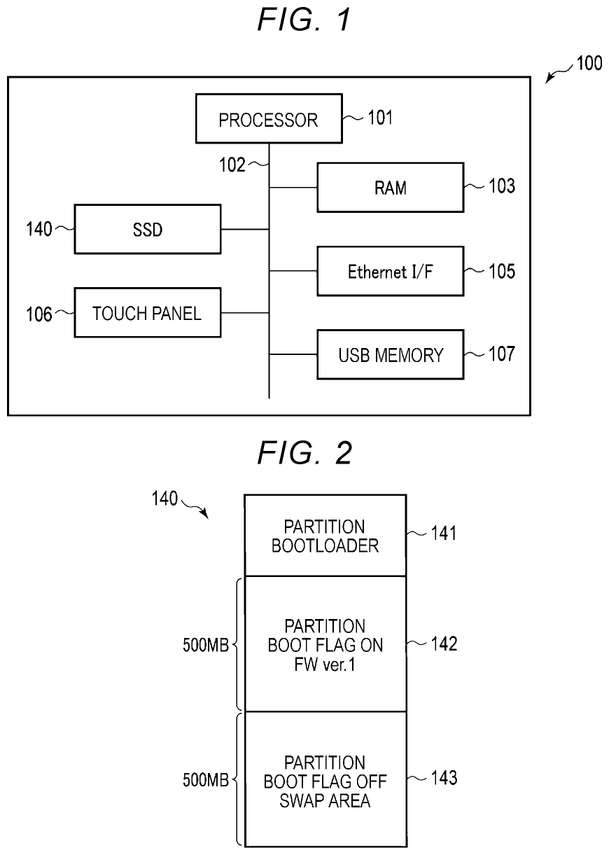

First, a hardware configuration of a computer 100 according to at least one embodiment will be described with reference to FIG. 1. FIG. 1 is a diagram illustrating the hardware configuration of the computer 100 according to at least one embodiment. The computer 100 is, for example, a personal computer, a server computer, or the like.

As illustrated in FIG. 1, the computer 100 includes a processor 101, a system bus 102, a RAM 103, a solid state drive (SSD) 140, an Ethernet (registered trademark) interface (I/F) 105, a touch panel 106, and a USB memory 107. The computer 100 may include other peripheral devices in addition to the components.

The processor 101, the RAM 103, the SSD 140, the Ethernet interface 105, the touch panel 106, and the USB memory 107 are electrically connected to each other via the system bus 102, and transmit and receive data and instructions via the system bus 102.

The processor 101 is hardware that executes a program and processes data. The processor 101 may include a central processing unit (CPU), a graphics processing unit (GPU), a digital signal processor (DSP), and the like. The processor 101 sequentially executes a series of instructions (programs) stored in the RAM 103. With such configuration, for example, data is read from the RAM 103 and processed, and the processed data is written to the RAM 103.

The RAM 103 is a main storage device (main memory) that temporarily stores the program and data. The RAM 103 temporarily stores the program and data necessary for processing currently being executed by the processor 101.

By executing the program, the RAM 103, the SSD 140, the Ethernet interface 105, the touch panel 106, and the USB memory 107 are controlled.

The touch panel 106 is an input and output device that receives input of an instruction and data and outputs data. The touch panel 106 receives the instruction and data by user's operation. The touch panel 106 presents various information to the user.

The Ethernet interface 105 is an interface for connecting with a network and other computers. For example, the computer 100 can be connected to a network or other computers via the Ethernet interface 105.

Both the SSD 140 and the USB memory 107 are auxiliary storage devices that permanently store data.

Both the SSD 140 and the USB memory 107 are auxiliary storage devices that can be used (utilized) as swap areas. That is, both the SSD 140 and the USB memory 107 can provide a virtual memory area for storing part of data currently stored in the RAM 103 if a capacity of the RAM 103 is insufficient.

The USB memory 107 is freely removable during operation of the computer 100. Accordingly, the USB memory 107 may not be connected to the computer 100. In other words, the computer 100 may not include the USB memory 107.

Here, the USB memory 107 is one representative example of an external storage device connected to the computer 100. The external storage device connected to the computer 100 is not limited to the USB memory 107, but may include other storage devices connected to the Ethernet interface 105, other storage devices wirelessly connected via wireless Wi-Fi (registered trademark), and the like.

The computer 100 may operate on a Linux (registered trademark) operating system (OS). The SSD 140 is a primary drive and the Linux OS is installed therein. The computer 100 operates by the processor 101 reading the Linux OS from the SSD 140 into the RAM 103 and executing the Linux OS if the power is turned on.

### Partition Structure

Next, a partition configuration of the SSD 140 will be described with reference to FIG. 2. FIG. 2 is a diagram illustrating the partition configuration of the SSD 140.

The SSD 140 is provided with three partitions 141, 142, and 143. Both the partition 142 and the partition 143 may have a capacity of 500 MB.

In the partition 141, a bootloader is installed. The bootloader manages a boot process of the computer 100. The bootloader is executed immediately after power is turned on, and controls procedures of initializing hardware and booting before the operating system (OS) and other software are loaded.

In the partition 142, firmware (FW) is installed. The firmware is version 1 (ver.1). In the partition 142, a boot flag is set to ON. That is, the partition 142 is set as a boot drive.

In the partition 143, the boot flag is set to OFF. The partition 143 is set as a swap area.

### Software Configuration

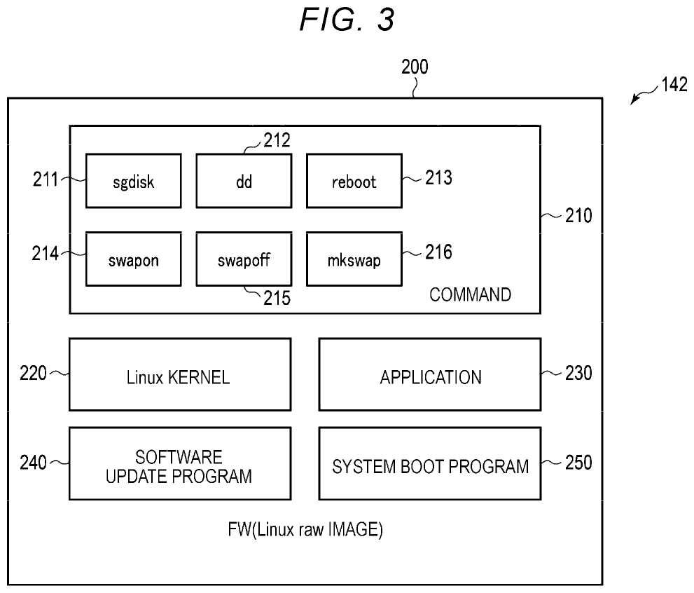

Next, with reference to FIG. 3, firmware 200 installed in the partition 142 of the SSD 140 will be described. FIG. 3 is a diagram illustrating a software configuration of the firmware 200 installed in the partition 142 of the SSD 140.

The firmware 200 is installed in the partition 142 of the SSD 140. The firmware 200 may be provided with commands 210, a Linux kernel 220, an application 230, a software update program 240, and a system boot program 250.

The commands 210 include a sgdisk command 211, a dd command 212, a reboot command 213, a swapon command 214, a swapoff command 215, and a mkswap command 216. The commands are used by the software update program 240 or system boot program 250.

The application 230 means general application software. The software update program 240 is, for example, a program that updates the firmware 200 or the application 230. The system boot program 250 is a program that boots a system provided with the firmware 200.

### Software Update

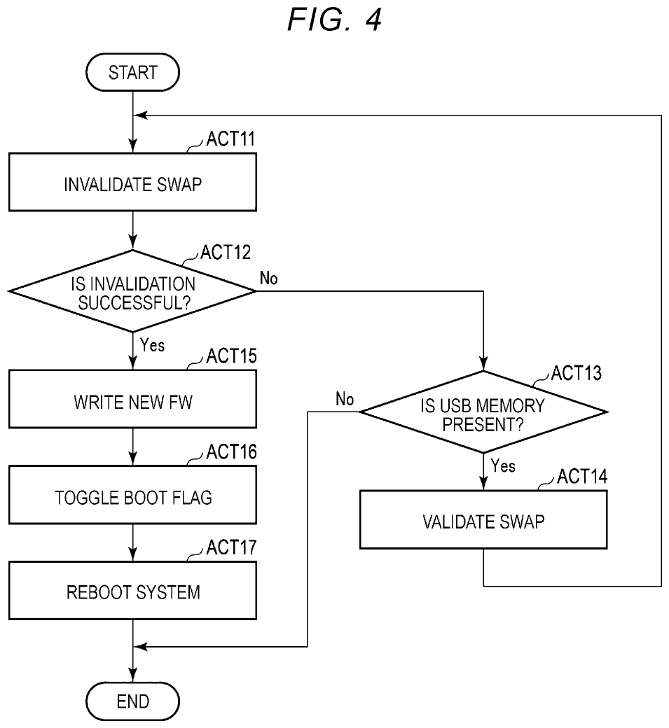

Next, software update in the computer 100 will be described with reference to FIGS. 4 to 8. FIG. 4 is a flowchart of a software update program of FIG. 3. The software update is performed by the processor 101 executing the code of the software update program 240. Here, an example of updating the firmware 200 from version 1 (ver.1) to version 2 (ver.2) will be described.

In ACT 11, the processor 101 executes the swapoff command 215 on the partition 143 of the SSD 140 set as a swap area to invalidate the swap area of the partition 143 of the SSD 140.

In ACT 12, the processor 101 determines whether invalidation of the swap area of the partition 143 of the SSD 140 is successful.

An example of failure in invalidating the swap area may include a state in which the partition 143 of the SSD 140 is currently being used as a swap area.

As the result of the determination in ACT 12, if the invalidation of the swap area fails, the processor 101 determines whether the USB memory 107 is connected, in ACT 13.

As the result of the determination in ACT 13, if the USB memory 107 is not connected, the processor 101 terminates the operation of software update.

As the result of the determination in ACT 13, if the USB memory 107 is connected, the processor 101 executes the mkswap command 216 on the USB memory 107 to initialize the USB memory 107 as the swap area, in ACT 14. Subsequently, the processor 101 executes the swapon command 214 for the USB memory 107 to validate the USB memory 107 as the swap area. Specifically, the processor 101 creates a swap file in the USB memory 107 and validates the swap file as the swap area. Accordingly, the use of the partition 143 of the SSD 140 as the swap area is stopped, and the USB memory 107 is used as the swap area.

After that, the operation flow returns to ACT 11 again. Since the use of the partition 143 of the SSD 140 as the swap area is stopped now, invalidation of the swap area of the partition 143 of the SSD 140 is successful.

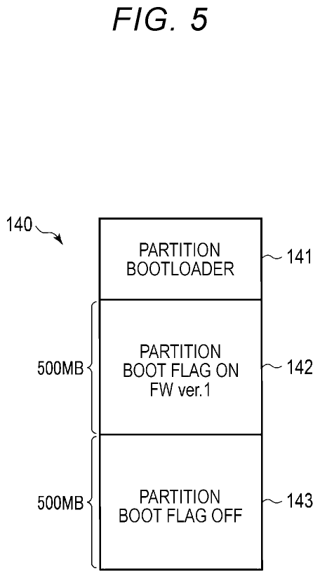

The partition configuration of SSD 140 for which the invalidation of the swap area of the partition 143 is successful as the result of the execution of ACT 11 is illustrated in FIG. 5.

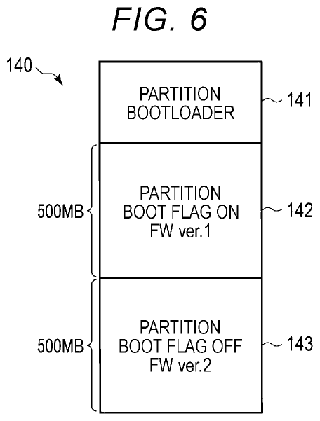

As the result of the determination in ACT 12, if the invalidation of the swap area is successful, the processor 101 writes version 2 of the firmware 200 to the partition 143 that is used as the swap area, in ACT 15. The partition configuration of the SSD 140 in which version 2 of the firmware 200 is written into the partition 143 is illustrated in FIG. 6.

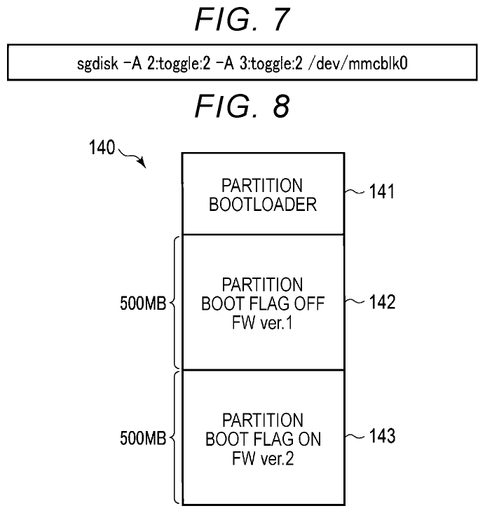

Next, in ACT 16, the processor 101 toggles the boot flags of the partition 142 and the partition 143. The boot flag is toggled by executing the sgdisk command 211. A specific example of the sgdisk command 211 to be executed is illustrated in FIG. 7. The partition configuration of the SSD 140 after toggling the boot flag is illustrated in FIG. 8. By executing the sgdisk command 211 illustrated in FIG. 7, ON/OFF of the boot flags of the partitions 142 and 143 are switched as illustrated in FIG. 8.

Finally, in ACT 17, the processor 101 executes the reboot command 213 to reboot the system.

### System Boot

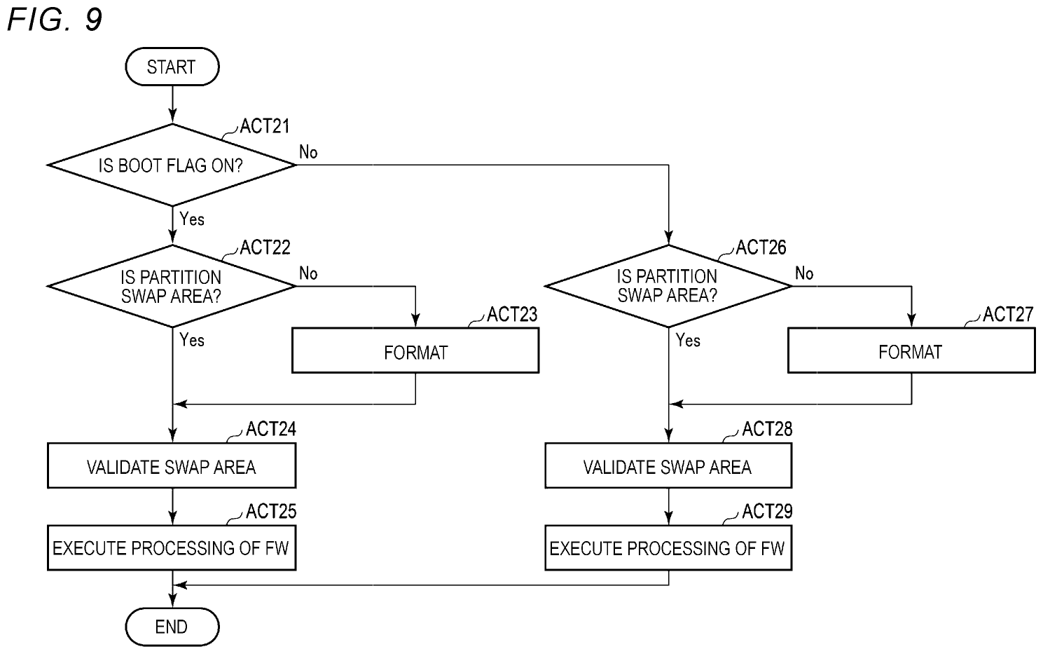

Next, system boot in the computer 100 will be described with reference to FIG. 9. FIG. 9 is a flowchart of the system boot program 250 of FIG. 3. The system boot is performed by the processor 101 executing the code of the system boot program 250.

In ACT 21, the processor 101 determines whether the boot flag of the partition 142 of the SSD 140 is ON if the system is booted.

As the result of the determination in ACT 21, if the boot flag of the partition 142 is ON, the processor 101 determines whether the partition 143 of the SSD 140 is a swap area, in ACT 22.

As the result of the determination in ACT 22, if the partition 143 of the SSD 140 is not the swap area, the processor 101 executes the mkswap command 216 on the partition 143 of the SSD 140 to format the partition 143 of the SSD 140 as the swap area, in ACT 23.

As the result of the determination in ACT 22, if the partition 143 of the SSD 140 is the swap area, or after processing of ACT 23, the processor 101 executes the swapon command 214 on the partition 143 of the SSD 140 to validate the partition 143 of the SSD 140 as the swap area, in ACT 24.

Subsequently, in ACT 25, the processor 101 executes the processing of the firmware 200.

As the result of the determination in ACT 21, if the boot flag of the partition 142 is OFF, the processor 101 determines whether the partition 142 of the SSD 140 is the swap area, in ACT 26.

As the result of the determination in ACT 26, if the partition 142 of the SSD 140 is not the swap area, the processor 101 executes the mkswap command 216 on the partition 142 of the SSD 140 to format the partition 142 of the SSD 140 as the swap area, in ACT 27.

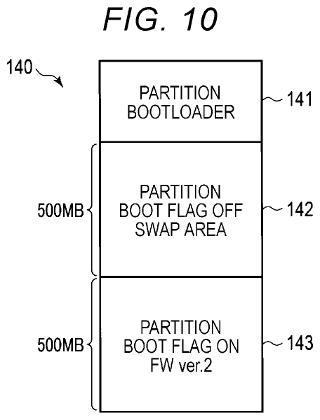

As the result of the determination in ACT 26, if the partition 142 of the SSD 140 is the swap area, or after processing of ACT 27, the processor 101 executes the swapon command 214 on the partition 142 of the SSD 140 to validate the partition 142 of the SSD 140 as the swap area, in ACT 28. The partition configuration of the SSD 140 after execution of ACT 28 is illustrated in FIG. 10.

Subsequently, in ACT 29, the processor 101 executes the processing of the firmware 200.

### Effect

According to at least one embodiment, it is not necessary to always secure a backup partition equivalent to software to be used only for the recovery of the software. The partition for software update with the backup left can be utilized as a swap area of a system memory except when updating.

The program according to at least one embodiment may be transferred while being stored in an electronic device, or may be transferred without being stored in an electronic device. In the latter case, the program may be transferred via a network, or may be transferred while being stored in a storage medium. The storage medium is a non-transitory tangible medium. The storage medium is a computer-readable medium. The storage medium may be any medium, such as a CD-ROM, a memory card, and the like, as long as the storage medium can store a program and is readable by a computer, regardless of the form thereof.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A computer comprising:
a storage having a first partition in which a current version of software is written and having a second partition provided as a swap area; and
a processor configured to:
control the storage,
invalidate the swap area of the second partition when updating the current version of the software to a new version of the software, and
write the new version of the software to the second partition.

2. The computer according to claim 1, wherein
the processor is configured to:
boot a system provided with the new version of the software after successfully writing the new version of the software, and
utilize the first partition as the swap area for the system provided with the new version of the software.

3. The computer according to claim 1, wherein:
the computer is further provided with an additional storage, wherein
the processor is configured to utilize the additional storage as the swap area for a system provided with the current version of the software when invalidation of the swap area of the second partition fails.

4. The computer according to claim 3, wherein the additional storage device is removably coupled to the computer.

5. A software update method for a computer including a storage having a first partition in which a current version of software is written and a second partition provided as a swap area, and a processor configured to control the storage, the method comprising:
invalidating the swap area of the second partition when updating the current version of the software to a new version of the software; and
writing the new version of the software to the second partition.

6. The method according to claim 5, further comprising:
booting a system provided with the new version of the software after successfully writing the new version of the software; and
utilizing the first partition as the swap area for the system provided with the new version of the software.

7. The method according to claim 5, wherein
the computer further is provided with an additional storage, and
the additional storage is utilized as the swap area for a system operating by using the current version of the software when invalidation of the swap area of the second partition fails.

8. The method according to claim 7, wherein the additional storage is removably coupled to the computer.

9. A computer readable medium storing instructions for performing a software update executable by a computer, the computer including a storage having a first partition in which a current version of software is written and a second partition provided as a swap area, and a processor, the instructions causing the computer to perform operations comprising:
invalidating the swap area of the second partition when updating the current version of the software to a new version of the software; and
writing the new version of the software to the second partition.

10. The computer readable medium according to claim 9, wherein the operations further comprise:
booting a system provided with the new version of the software after successfully writing the new version of the software; and
utilizing the first partition as the swap area for the system provided with the new version of the software.

11. The computer readable medium according to claim 9, wherein
the computer is further provided with an additional storage, and
the additional storage is utilized as the swap area for a system operating by using the current version of the software when invalidation of the swap area of the second partition fails.
